(19) United States
(12) Patent Application Publication
(10) Pub. No.: US 2023/0361351 A1
(43) Pub. Date: Nov. 9, 2023

(54) Sulfolane Based Electrolyte For High Voltage Rechargeable Lithium Batteries

(71) Applicants: Lin-Shu Du, Lansdale, PA (US); Brendan Hayes-Oberst, West Chester, PA (US); Chao Shen, Hatfield, PA (US)

(72) Inventors: Lin-Shu Du, Lansdale, PA (US); Brendan Hayes-Oberst, West Chester, PA (US); Chao Shen, Hatfield, PA (US)

(21) Appl. No.: 17/803,310

(22) Filed: May 3, 2022

(51) Int. Cl. H01M 10/0569; H01M 10/0525; H01M 4/58; H01M 4/38

(52) U.S. Cl. CPC H01M 10/0569; H01M 10/0525; H01M 4/582; H01M 4/386; H01M 2300/0028; H01M 2004/028

(57) ABSTRACT

Disclosed herein are novel, high salt concentration, sulfolane based electrolytes with a sulfone cosolvent(s), which are at their eutectic concentrations to lower the melting points of the electrolytes. The lower melting point electrolytes improve the low temperature performance of high voltage rechargeable batteries. The high salt concentration electrolytes improve the cycle performance of rechargeable lithium metal anode based batteries. The same electrolytes can operate above 4.3 V and up to 5.0 V vs. Li/Li⁺. Various cells containing said electrolytes are also disclosed herein.

### BACKGROUND OF THE INVENTION

### Field of the Invention

This invention relates to a sulfolane based electrolyte for high voltage (up to 5 V) rechargeable lithium metal and lithium-ion batteries. These batteries have longer cycle life (stable lithium stripping/plating) and have lower operating temperatures than existing high voltage sulfolane based lithium batteries, due to the use of a sulfone cosolvent(s) in the electrolyte and having the solution at its eutectic or near eutectic concentration, and due to the use of high molar loading of the salt in the electrolyte.

### Description of the Prior Art

It has been recognized that there is a need for safe, long lasting, high voltage rechargeable cells with a wide operating temperature range.

A rechargeable lithium battery is an electrochemical energy storage device, which typically comprises an intercalating metal oxide compound cathode, a lithium metal or a silicon or carbon based anode, a porous electrically non-conductive separator between said cathode and anode, a non-aqueous liquid electrolyte in contact with both electrodes, and a moisture-proof enclosure. The output voltage of a lithium battery is determined by the difference in electrochemical potentials between the cathode and anode. Thus, design of proper cathode system is of prime importance to realize a high energy density (capacity x voltage per weight) to outperform other available battery systems.

There are emerging high voltage cathode materials, such as LiMn₂O₄ and LiNiF₂, that have their operating potentials in part or entirely above the oxidation stability limit of conventional non-aqueous electrolytes (4.3 V vs. Li/Li⁺). To enable the use of these materials in lithium battery, many new electrolytes with improved chemical stability at high voltage range (such as 5.0 V vs. Li/Li⁺) have been investigated. One class of organic electrolyte solvents that has received attention are the sulfones having wide electrochemical window (can be stable at 5.0 V vs. Li/Li⁺) and high safety (low flammability, due to high boiling point).

However, the issue of sulfone based electrolyte is its high melting point and high viscosity. Sulfones can be divided into two types: 1) cyclic or aromatic sulfones, and 2) aliphatic sulfones. The use of the cyclic sulfones, i.e., sulfolane (tetramethylenesulfone) along with its alkyl-substituted derivatives, 3-methylsulfolane and 2,4-dimethysulfolane, as electrolyte solvents has been investigated by researchers.

U.S. Pat. No. 3,079,597 of Mellors, et al. and U.S. Pat. No. 5,219,684 of Wilkinson et al. both describe the use of sulfolane or its alkali-substituted derivatives as the main electrolyte solvent for battery applications. Low viscosity cosolvents, such as 1,3-dioxolane and glyme, were mixed with sulfone(s) to overcome the high viscosity issue. U.S. Pat. No. 6,245,465 of Angell, et al. describes the use of non-cyclic sulfones or fluorinated non-symmetrical non-cyclic sulfones, having lower melting temperatures, as the electrolyte solvents for secondary battery applications. The patent also describes the use of cosolvents such as carbonates, glymes, siloxanes and others.

U.S. Pat. No. 8,679,684 of Kolosnitsyn, et al. describes a sulfolane based electrolyte for a lithium-sulfur battery, which electrolyte comprises solution that is eutectic or close to eutectic. By using the eutectic mixture, the performance of the electrolyte and battery at low temperatures is much improved.

It should be noted, that the cosolvents that were used herein to mix with sulfones to improve the low temperature performance are usually not stable at high voltage (>4.3 vs. Li/Li⁺) and are highly flammable.

Despite the numerous electrolytes proposed for use in rechargeable lithium batteries, there remains a need for improved non-aqueous electrolyte compositions that enable the use of high voltage cathode and operation of the battery at low temperatures.

### SUMMARY OF THE INVENTION

It has now been found, that the use of mixed sulfolane/sulfone electrolyte can lower the meting point of the electrolyte and yet still maintain the high voltage stability. The lower melting temperature is possible by mixing sulfolane solvent with a sulfone cosolvent(s), which solution is at its eutectic or near eutectic concentration, and by adding a lithium salt with concentration higher than 2.0 M or 2.0 m. This permits the operation of high voltage lithium batteries at a lower temperature.

The principal object of the invention is to provide sulfolane based electrolyte with a sulfone cosolvent(s) having lower meting point, and thus improving the low temperature performance of lithium batteries.

A further object of the invention is to provide high salt concentration sulfolane based electrolyte with a sulfone cosolvent(s), thus improving the lithium cycling stability at high voltage.

A further object of the invention is to provide safer and non-flammable, high energy density lithium batteries.

Other objects and advantages of the invention will be apparent from the description and appended claims.

### BRIEF DESCRIPTION OF THE DRAWINGS

The nature and characteristic features of the invention will be more readily understood from the following description taken in connection with the accompanying drawing forming part thereof, in which:

FIG. 1 is the temperature versus the mole fraction diagram for the sulfolane-butyl sulfone mixtures, showing the melting point as a function of solvent mixture ratio.

FIG. 2 is the temperature versus the mole fraction diagram for the sulfonlane-methyl phenyl sulfone mixtures, showing the melting point as a function of solvent mixture ratio.

FIG. 3 is the temperature versus the mole fraction diagram for the sulfolane-ethyl methyl sulfone mixtures, showing the melting point as a function of solvent mixture ratio.

FIGS. 4a, 4_{b} & 4_{c} are the voltage versus cycle time plots for Li/Li symmetric cells using sulfolane based electrolyte (4a and 4b) in comparison with conventional carbonate based electrolyte (4c), cycling with an areal capacity of 1 mAh/cm² at a current density of 1 mA/cm².

It should of course, be understood that the description and drawings herein are merely illustrative, and that various modifications and changes can be made in the compositions and the structures disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents, which operate and function substantially same way to bring about the same results.

According to one embodiment of the present invention, there is provided an electrolyte for high voltage rechargeable lithium batteries. The electrolyte comprises a solution of at least one lithium salt in at least two aprotic solvents, such as sulfolane and a sulfone, wherein concentration of the components of the solution is selected so that the solution is at its eutectic or near eutectic concentration, or within at most 30% of its eutectic concentration.

The use of eutectic or near eutectic compositions dramatically decreases the melting point of the electrolyte, and therefore improves low temperature performance properties of the electrolyte.

The sulfone cosolvent comprises one or more non-symmetrical, non-cyclic sulfones of the general formula: R¹—SO₂—R², wherein R¹ and R² are independently linear or branched alkyl or partially or fully fluorinated linear or branched alkyl groups having 1 to 7 carbon atoms; wherein R¹ and R² are different; and wherein —SO₂—denotes the sulfone group. In another embodiment 121 and R² have 1 to 4 carbon atoms.

In another embodiment, the alkyl group is selected from the group consisting of methyl (—CH₃), ethyl (—CH₂CH₃), n-propyl (—CH₂CH₂CH₃), n-butyl (—CH₂CH₂CH₂CH₃), n-pentyl (—CH₂CH₂CH₂CH₂CH₃), n-hexyl (—CH₂CH₂CH₂CH₂CH₂CH₃), n-heptyl (—CH₂CH₂CH₂CH₂CH₂CH₂CH₃), iso-propyl (—CH(CH₃)₂), iso-butyl (—CH₂CH(CH₃)₂), sec-butyl (—CH(CH₃)(CH₂CH₃)), tert-butyl (—C(CH₃)₃), and iso-pentyl (—CH₂CH₂CH(CH₃)₂). In a preferred embodiment, the sulfone is ethylmethyl sulfone (CH₃—CH₂—SO₂—CH₃). The electrolytes of the present invention have a stability to oxidation of greater than 4.3 V vs and Li/Li⁺ and up to 5.0 V vs. Li/Li⁺.

The electrolyte salt may be at least one lithium salt selected from the group comprising: Li(CF₃SO₂)₂N (LiTFSI), Li(FSO₂)₂N (LiFSI), LiPF₆, LiBF₄, LiSbF₆, LiAsF₆, LiN(SO₂C₂F₅)₂, Li(CF₃SO₃)₂N, LiN(SO₃C₂F₅)₂, LiC₄F₉SO₃, LiClO₄, LiAlO₂, LiAlCl₄, LiCl, LiI, LiB(C₂O₄)₂ (LiBOB); and their mixtures.

The lithium salt may be used in a concentration of higher than 2.0 M or 2.0 m. The electrolyte may further include at least one organic or inorganic additive for contributing to a solid electrolyte interface (SEI) formed on the surface of the anode, and thus improving cycling. Amount of the additive is preferably between 0.2% and 10% of the total mass of the electrolyte.

According to another embodiment of the present invention, there is provided a high voltage lithium battery comprising at least one lithium metal or a carbon or silicon based negative electrode, at least one positive electrode with a high average voltage in discharge (e.g., >4.3 V vs. Li/Li⁺), at least one porous, electrically non-conductive separator between the positive and negative electrodes, and an electrolyte as described above.

In embodiments of the present invention the cathode may contain an active high voltage material selected from the group consisting of: nickel manganese oxide, nickel cobalt manganese oxide, nickel fluoride, and their lithiated versions. Examples of the embodiments will hereinafter be described in detail. However, these embodiments are just examples and are not limiting the present invention.

### Example 1

Sulfolane is mixed with butyl sulfone with varying molar concentrations and the melting points of the mixed solutions are measured. The eutectic point is determined as the lowest melting temperature over all the mixing ratios for the two species.

### Example 2

The eutectic point is measured according to the same method as Example 1, except for mixing sulfolane with methyl phenyl sulfone.

### Example 3

The eutectic point is measured according to the same method as Example 1, except for mixing sulfolane with ethyl methyl sulfone.

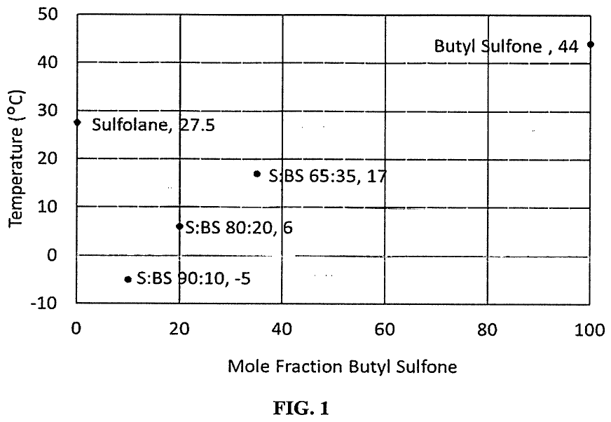

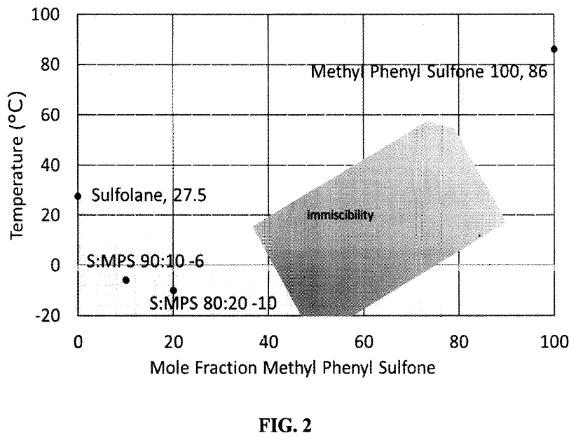

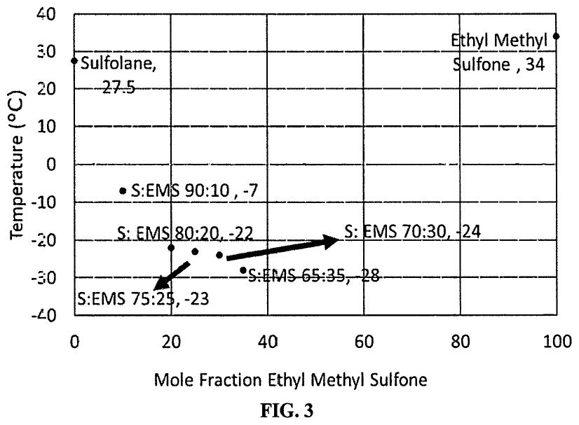

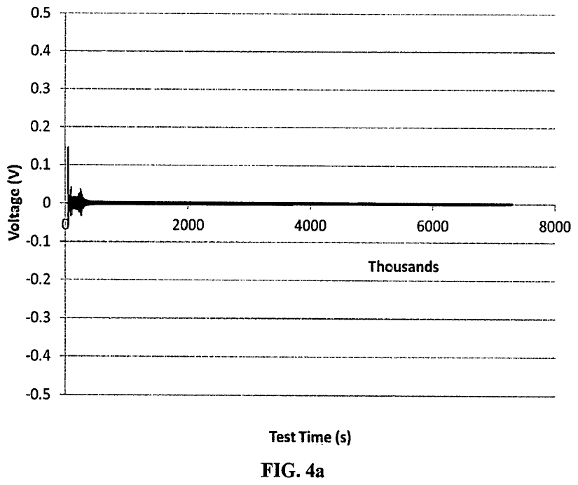

The melting points for the sulfolane and three sulfone based cosolvents, i.e., butyl sulfone, methyl phenyl sulfone, and ethyl methyl sulfone are shown in FIG. 1, FIG. 2, and FIG. 3, which are embodiments of the invention. The eutectic point of methyl phenyl sulfone and sulfolane system cannot be determined due to the poor miscibility of the two solvents. Butyl sulfone and sulfolane system has a eutectic point of −5° C. when mixed. The ethyl methyl sulfone and sulfolane system has a eutectic melting point of −28° C. The relatively low eutectic point is most likely due to ethyl methyl sulfone's lower melting point (32-37° C.) than other sulfone candidates and its bent CH₂—CH₃ group resulting in higher entropy of mixing.

### Example 4

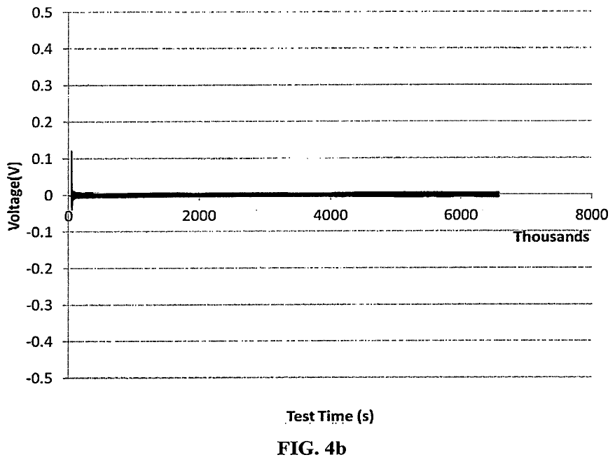

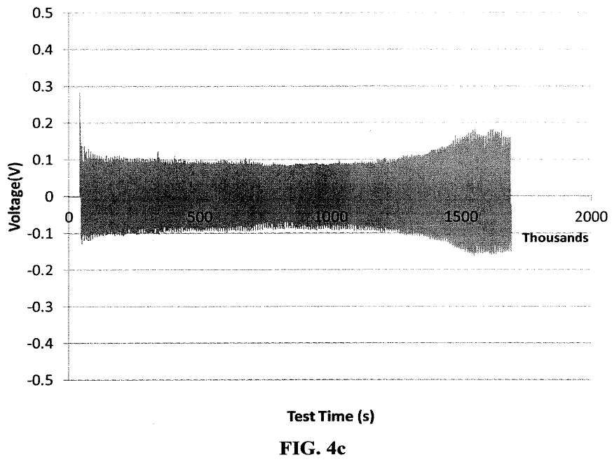

A CR2032-type coin cell was fabricated by assembling two lithium metal disks sandwiching a glass fiber separator. 200 μL of electrolyte 2 M LiFSI in sulfolane/ethyl methyl sulfone (65:35 by mole ratio) was injected in the coin cell. The test diagram is shown in FIG. 4a showing stable Li stripping/plating voltage profile.

### Example 5

A CR2032-type coin cell was fabricated according to the same method as for the Example 4, except for using electrolyte 3 m LiFSI in sulfolane/ethyl methyl sulfone (65:35 by mole ratio). The test diagram is shown in FIG. 4b showing stable Li stripping/plating voltage profile.

### Example 6

A CR2032-type coin cell was fabricated according to the same method as for the Example 4, except for using carbonate based electrolyte 1 M LiPF₆ ethylene carbonate/diethyl carbonate (1:1 by volume), and a polyethylene separator. The test diagram is shown in FIG. 4c showing unstable Li stripping/plating voltage profile.

It can be seen, that the lithium cycling performance of coin cells with an areal capacity of 1 mAh/cm² at a current density of 1 mA/cm² with the two high concentration sulfolane based electrolytes (Example 4 & 5) are much better than that with a carbonate based electrolyte (Example 6), showing both smaller overpotentials and longer and stable cycle life.

Thus the sulfolane/sulfone electrolytes with high salt concentrations have been provided herein, with which the objects of the invention are achieved.

We claim:

1. A non-aqueous electrolyte for high voltage lithium metal and lithium-ion batteries, comprising a mixture of high boiling point solvents selected from the group consisting of: sulfolane, ethyl methyl sulfone, butyl sulfone, and methyl phenyl sulfone, and having a lithium salt of at least 2 molar concentration dissolved therein.

2. A non-aqueous electrolyte as described in claim 1, in which said lithium salt is selected from the group comprising: Li(CF₃SO₂)₂N (LiTFSI), Li(FSO₂)₂N (LiFSI), LiPF₆, LiBF₄, LiSbF₆, LiAsF₆, LiN(SO₂C₂F₅)₂, Li(CF₃SO₃)₂N, LiN(SO₃C₂F₅)₂, LiC₄F₉SO₃, LiClO₄, LiAlO₂, LiAlCl₄, LiCl, LiI, LiB(C₂O₄)₂ (LiBOB); and their mixtures.

3. A non-aqueous electrolyte as described in claim 2, in which said mixture is at eutectic concentration.

4. A non-aqueous electrolyte as described in claim 2, in which said mixture is within 30% of its eutectic concentration.

5. A non-aqueous electrolyte as described in claim 2, which can operate in voltage above 4.3 V vs. Li/Li⁺.

6. A non-aqueous electrolyte as described iii claim 2, which can operate at low temperatures down to −28° C.

7. A safe, non-aqueous high voltage lithium battery cell having operating voltage above 4.3 V vs. Li/Li⁺ at low temperatures down to −28° C., which cell compromising a lithium metal anode(s); a high voltage mixed oxide cathode(s); a porous electrically non-conductive separator(s); a sulfolane/sulfone based electrolyte with a lithium salt(s) dissolved therein at eutectic concentration; and a moisture-proof enclosure.

8. A safe, non-aqueous high voltage lithium battery cell having operating voltage above 4.3 V vs. Li/Li⁺ at low temperatures down to −28° C., which cell compromising a carbon anode(s), a high voltage lithiated mixed oxide cathode(s); a porous electrically non-conductive separator(s), a sulfolane/sulfone based electrolyte with a lithium salt(s) dissolved therein at eutectic concentration, and a moisture-proof enclosure.

9. A non-aqueous high voltage battery cell as described in claim 7, in which said electrolyte is as described in claim 2.

10. A non-aqueous high voltage battery cell as described in claim 8, in which said electrolyte is as described in claim 2.

11. A non-aqueous high voltage lithium battery cell as described in claim 7, in which said mixed oxide cathode is replaced with a nickel fluoride cathode.

12. A non-aqueous high voltage lithium battery cell as described in claim 8, in which said lithiated mixed oxide cathode is replaced with a lithiated nickel fluoride.

13. A non-aqueous high voltage lithium battery cell as described in claim 8, in which said carbon anode is replaced with a silicon anode.

14. A non-aqueous electrolyte as described in claim 2, in which said electrolyte mixture comprising sulfolane and ethyl methyl sulfone in 65:35 by molar ratio, and said salt is 2 M LiFSI.

15. A non-aqueous electrolyte as described in claim 2, in which said electrolyte mixture comprising sulfolane and ethyl methyl sulfone in 65:35 by molar ratio, and said salt is 3 m LiFSI.
